(19) United States
(12) Patent Application Publication
(10) Pub. No.: US 2008/0021768 A1
(43) Pub. Date: Jan. 24, 2008

(54) Method and system for improved project delivery

(76) Inventor: Romey Ross, Littleton, CO (US)

Correspondence Address: REILLY INTELLECTUAL PROPERTY LAW FIRM, 1554 EMERSON STREET, DENVER, CO, 80218, US

(21) Appl. No.: 11/481,622

(22) Filed: Jul. 5, 2006

(51) Int. Cl. G06F 11/34

(52) U.S. Cl. 705/11

(57) ABSTRACT

A method and system for project management and delivery of a project through contractual agreements providing for reimbursement, compensation and incentive programs. The members may be selected by a team leader based on defined criteria and training workshops may be conducted to identify the reimbursement, the compensation and the incentive programs to be included in the contractual agreements.

This invention relates to project management and, more particularly, to a method and system of project management and delivery through use of reimbursement and compensation programs, training workshops and contractual agreements.

### BACKGROUND AND FIELD

Current methods and systems of project management require coordination between a number of different parties having a variety of business objectives, available resources and business constraints. The current approaches to management and delivery of projects result in delays and duplication of efforts as well as budget shortfalls. Undesirable effects consistently observed across a wide range of projects, varying only in degree, include but are not limited to the following:

Pre-construction services are inadequate or inaccurate; early conceptual design level cost estimates are often not timely and are typically not very accurate when compared to the eventual negotiated cost or bids; interactive cost estimating assistance to a design team is typically not timely, therefore not interactive, by definition; early schedules are typically insufficiently detailed and insufficiently correlated with early estimates; and early schedules are typically not validated by calculating the labor resources that will be required to achieve proposed durations and determining the likelihood of availability of such labor in the time frames represented by the schedule.

Completion of detailed design documents fall short of what is needed, leading to costly re-work resulting in impacts to other design elements and/or trades; shop drawings or shops are typically started later than would be ideal for adequate cross-discipline coordination and in-depth review. Development, and especially designer review, of shops are typically both based on the assumption that a good quality, complex “product” (in this case shops) will be developed by one group in isolation (often physically remote), then “pitched over the fence” to another group, typically the designers, who will then review them in isolation, make cryptic notes/comments and “pitch them over the fence” back to the originators to make revisions, refinements or corrections. This approach almost ensures multiple miscommunications, errors, waiting, re-work, and generally lower quality than the participants are capable of producing. Review notes such as “Unless Noted Otherwise”, “No Exceptions Noted”, or the catchall “Revise and Resubmit” often appear to be used as shortcuts (or supposed time savers) in place of definite confirmation that the designer's intent is clearly expressed and understood. Multiple cycles of “over the fence” reviews and re-submittals are common. Further, many significant, and often costly, changes are caught very late in the project. Many such changes are only discovered in the field as construction proceeds and/or after off-site fabrication (again leading to waiting and re-work).

Furniture, Fixtures and Equipment (FFE) as well as low voltage communications, control systems and Information Systems Technology (IST) are typically not well coordinated with the other design documents. This results in budget shortfalls as well. All of the problems with shops noted above also occur with FFE and IST. The problems are exacerbated by the fact that most owners intend to procure FFE and IST items directly but want their purchases coordinated with the design and installed by the constructor. Impacts of late changes due to revisions from manufacturers, technology changes, or due to revised owner choices cannot be readily separated from impacts due to inadequate design coordination with the FFE and IST shops. Most designers exclude all, or part, of the FFE and IST design coordination from their contractual obligations. Most constructors, and generally most designers, do not analyze the project schedule early enough, nor in sufficient detail, to determine the No-Later-Than (NLT) dates by which FFE and IST elements must be delivered on-site. In the absence of such NLT information, most owners do not calculate shipping, fabrication, ordering, and design lead times, and therefore have no deadlines concerning the dates by which they must choose and purchase such items in order to avoid delays to the project. The net result is that FFE and IST conflicts produce much waiting and re-work, resulting in unnecessary costs and/or delays to construction, as well as costly FFE/IST re-orders and changes late in the project. In summary, inadequate and inaccurate pre-construction services, conceptual designs, detailed designs and FFE/IST estimates result in project delays, budget shortfalls and inferior project performance.

### SUMMARY

It is therefore desirable to provide a method of project management and project delivery between an owner, one or more constructors and one or more designers by selecting team members comprised at least in part of constructors and designers, and codifying agreements between the owner and the team members to: define each team members duties; provide for reimbursement to selected of the team members for performing preliminary tasks including but not limited to interactive conceptual design, pre-construction planning, interactive review of drawings and submittals, and design and cost estimates; provide for compensation of selected of the team members based on the duties, and providing incentives to each of the team members as a means for motivating the team members. The method includes appointing a team leader to select the team members by utilizing various of the TAP criteria such as: quality of previous work, personnel availability, grasp of interactive design completion and estimation, and fees. The method also includes conducting training workshops to identify the duties, the reimbursement, the compensation, the incentives and the root causes. A system has been devised of achieving timely and cost-effective project delivery which is comprised of a database having one or more of the following fields of information: a selection module based on criteria for obtaining desired members; a compensation module defined by payment structures; a reimbursement module for defined preliminary duties or tasks; an incentive module defined by bonus structures, a training module defined by workshops implementing for example, cause and effect analyses to identify root causes; and an agreement module defined by a contract table for developing contract proposals specifying duties, reimbursements, compensations and incentives.

A few goals of the method and system of project management and project delivery are set forth as follows: to provide a method of efficient project delivery through enhanced teamwork as the result of overcoming problems inherent in current approaches; to provide a method that achieves the major stakeholders' (e.g. owner's, designer's, constructor's project-related goals mutually and to reduce risk to the designer and to the constructor, thereby eliminating major constraints to their active and willing participation in effective teamwork at key stages of a project; to provide a method that ensures selection of designers and constructors who demonstrate the appropriate management skills to work within the system; to provide a method that generates improvements to quality, reduces project duration, and/or reduces overall cost which can then be used to establish a shared savings pool from which team members may earn portions as incentive for performance; to write original contracts, or modify typical form contracts codifying each team member's duties, explicitly defining the removal of specific risks, and identifying the conditions which will govern the earning of incentives; to achieve team “buy-in” and commitment through techniques that cause the team to: discover root causes of common problems; develop breakthrough, high leverage solutions to identified causes/problems; commit themselves to applying the solutions; implement the solutions by applying relevant planning, policy, and procedure tools; and to provide a method that can be implemented by a computer system and/or knowledge management system that will guide users through multiple branching decision pathways.

### Definitions

“Constructor” refers to any entity responsible for building, constructing or in any way assembling the plans of a project. This includes contractors and sub-contractors.

“Designer” refers to all entities or parties responsible for the creation of a project. This includes architects, engineers, draftsmen, research and development entities, by way of example but not limitation.

“Owner” refers to any party or entity responsible for commissioning, requesting and/or paying for project delivery.

“Project” includes but is not limited to any object created by the joint effort of parties or entities.

### BRIEF DESCRIPTION OF THE DRAWINGS

FIG. 1 is a diagram illustrating a method of project management and delivery;

FIG. 2 is a flow chart illustrating goals, collaboration and elements required; and

FIG. 3 is an example of a portion of a Team Responsibility Matrix.

### DETAILED DESCRIPTION

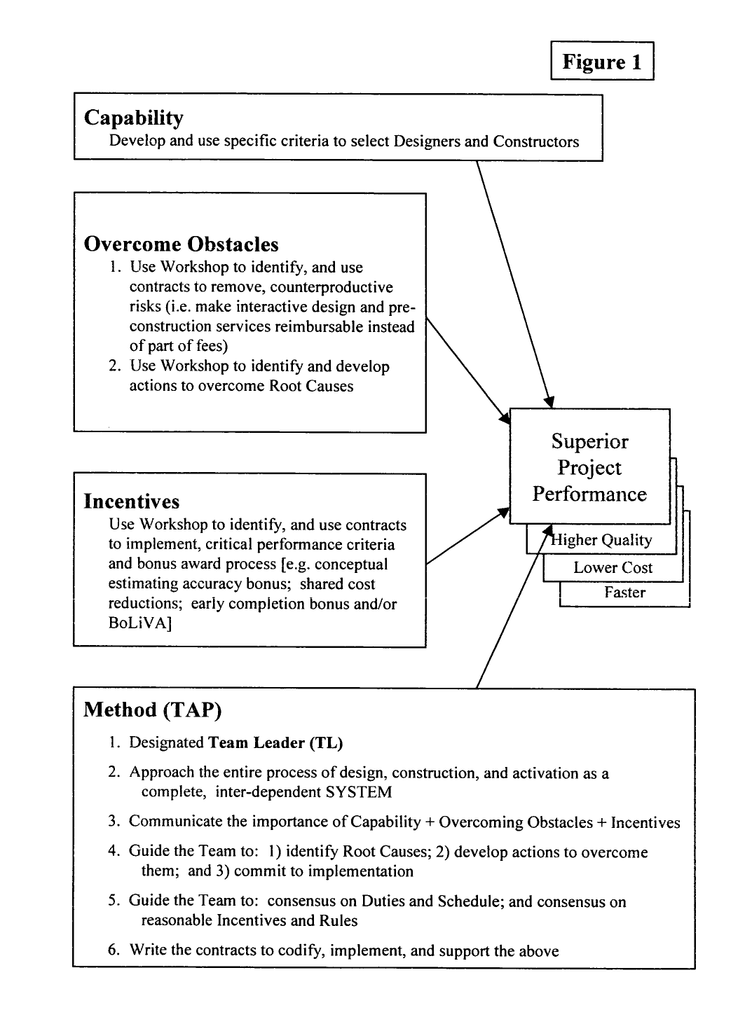

Referring in detail to the drawings, FIG. 1 illustrates a method of project management and delivery through team member selection (Capability), reassignment of selected tasks to a reimbursable category resulting in the removal of counterproductive risk (Obstacles). This information may be stored and retrieved from a computer database. Profit is provided through compensation to team members, motivation is provided through performance based incentives (Incentives), and appointing a team leader for obtaining commitment of all parties involved through contractual agreements and training workshops (Method). The result is superior project performance consisting of a higher quality product, completed on-schedule or ahead of schedule, at a lower cost. Capability is addressed through use of special processes and criteria for selection of team members. The constructor and the designer make up a group designated as “team members”, “members” or “necessary parties” and the team leader includes, but is not limited to, a third party responsible for guiding and implementing the Method. These categories are not mutually exclusive as some roles may be shared between entities. For example, the team members will typically consist of one or more designers and one or more constructors with demonstrable project management capabilities, rather than selection based on low fees only. This information may be stored and retrieved from a computer database, referred to as a “Selection Module”. Obstacles are overcome by conducting training workshops to identify and use contracts to remove counterproductive risks and to identify and develop actions to overcome root causes of typical team dysfunctions. Use of a database to conduct or store and retrieve all or a part of the training workshops is referred to as a “Training Module”. Compensation is addressed through payment structures for project completion. The payment structures may be stored on a computer database, also referred to as a “Compensation Module”. Counterproductive risks are removed by reimbursement for select preliminary tasks. Reimbursement information may be stored and retrieved from a computer database, also referred to as a “Reimbursement Module”. Incentives are addressed through the establishment and use of monetary rewards partially defined by profits or a bonus award process. This information may be stored and retrieved from a database and is referred to as an “Incentive Module”.

The Method is achieved through the implementation of any parts of, or combination of parts of, unique partnering techniques that lead teams to discover root causes of problems, develop effective high-leverage solutions and commit to the solutions through an agreement with the guidance of a designated team leader. As set forth previously, the present method and system includes a software component or information stored in the database of a computer, to aid in the compilation of necessary data that will guide users through multiple branching decision pathways influenced by elements such as: team member goals, parameters defining cost, time, quality, and other success criteria, availability of design and constructor's entities and their relevant capabilities, preferred procurement methods (contract types; purchasing policies), design complexity, and owner policies and/or legal constraints. The database also allows for activation of modules to enable display of categories of information listed in a drop-down menu. The database further includes a contract table for developing contract proposals, also referred to a an “Agreement Module”. The modules referred to above are broadly referred to as “fields of information” that may be retrieved and displayed in order to facilitate utilization of the Method.

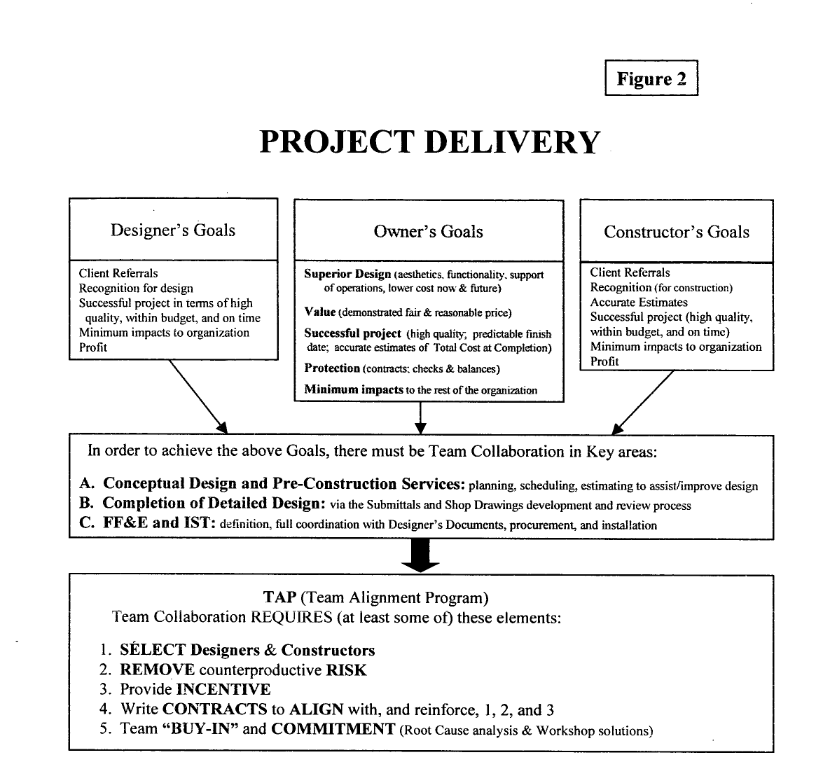

FIG. 2 demonstrates the overall relationship between the team which may include an owner, designer(s), constructor(s) or contractor(s) and a team leader. The owner, the constructor and the designer have individual goals, some identical, such as a successful project in terms of high quality, within budget and on-time delivery. In order to achieve the owner's, the designer's, and the constructor's goals, team collaboration must be present in at least three key areas as shown in FIG. 2:

1. Conceptual Design and Pre-Construction Services: The planning, scheduling, and estimating of conceptual designs at an early stage is critical to assist and improve project delivery. The conceptual design, typically generated by the designer, is based on fundamental information from programming, general site constraints and overall preferred layout of a design. Pre-construction services or interactive cost estimates are generated, typically by the constructor, based on the conceptual design. Generation of the estimates typically result in revised designs and further revised estimates until the designer, and/or team leader, determines the design to be sufficiently refined to go on to the next level.

2. Completion of Detailed Design: Early completion of the detailed design via the submittals and shop drawings development and review process results in fewer changes at a later time period. This is consistent with historical precedent, but most owners and many constructors utilize the conceptual designs as the definitive, detailed, design documents which define precisely how the facility will be constructed. In reality, submittals and shop drawings are the de facto detailed construction design documents for most major building systems such as, but not limited to, mechanical heating, ventilating, and cooling systems, plumbing systems, electrical systems, fire protection, low voltage systems, structural systems, light gauge framing, roofing, and glazing systems.

3. Furniture, Fixtures, and Equipment (“FF&E”) and Information Systems Technology, low voltage communications and control systems (“IST”): Another important area is the definition, development, review, selection, full coordination with designer's documents, procurement, and installation of the FF&E as well as IST. These areas can add major unanticipated expenses and delays in project delivery if not properly and adequately developed at an early stage.

In order to obtain effective team collaboration, as set forth above, the solution, referred to as Team Alignment Program (“TAP”), requires at least some, and preferably all of the following elements:

1) select designers and constructors who meet the established TAP criteria;

2) convert defined tasks to a reimbursable category;

3) provide increased profit or compensation through “earned share saving” structure;

4) codify and execute contracts to implement elements 1, 2 & 3;

5) define each team member's duties through a team leader by conducting proprietary Training Workshops developed by Technical Project Services, Inc (“TPS”) to determine root causes, develop effective solutions, commit to the solutions, and implement the solutions through the use of appropriate planning, policy and procedure tools.

The following is a discussion of the steps to be followed in order to achieve optimum project management and delivery:

Change the basis of the designer selection. The following criteria are to be considered in the selection of the designer: Along with quality of previous design work, and equal to it in importance, rank each firm's design schedule making it a requirement of the proposal, including labor assignments. This assures the availability of the designer during critical periods in the design and construction phases. Confirm the validity of the proposed schedule (i.e. the resources shown are available in the proposed time frames). Test proposed personnel for grasp of their potential roles in cost estimating interaction and the effects on early design. Likewise test for grasp of their potential roles in “design completion” interaction during the review and refinement of key shop drawings and submittals. If the designer has already been selected, then at least apply the same requirements for design schedule, resource assignments, and overall management of the design process. If possible, revise the contract to reflect these aspects.

Change the basis of the constructor selection. Along with recommendations from other owners, safety record, etc., and equal to these in importance, evaluate and rank each firm's proposed pre-construction support services plan/schedule, making it a requirement of the proposal, including labor assignments. This aids in timely project completion. Confirm the validity of the proposed schedule (i.e. the resources shown are available in the proposed time frames). Test proposed personnel for grasp of their potential roles in cost estimating interaction and the effects on early design. Likewise test for grasp of their potential roles in “design completion” interaction during review/refinement of key shop drawings and submittals.

After selection of the designer and the constructor, identify portions of each of their work plans or schedules associated with: interactive preliminary conceptual design, pre-construction planning, design and cost estimates including interactive review and refinement of shop drawings and submittals. Take those portions out of the fee or compensation to be paid for the project and convert them to a direct reimbursement category. Time spent on these tasks are to be reimbursed apart from any fees or compensation earned. This has the effect of removing important elements of counterproductive risk for each firm or member. Counterproductive risk creates obstacles to timely completion of projects. Adjust the Total Project Budget (“TPB”) to reflect these changes and to control them. The degree of effective interactive involvement between the designer and constructor in developing designs and estimating costs has a significant impact on the entire project. The typical selection process of the designers and the constructors places an emphasis on low fees, therefore the firms competing for a job are inclined to reduce their fee as much as possible to secure the contract. As a result, the early designs are performed in a minimal fashion with a resulting estimate that is inaccurate. The TAP approach looks at this common approach as counterproductive. Since it is difficult to anticipate the amount of time and labor required to achieve the desired conceptual design and estimate, contracts between the members are revised to assign the interactive design and estimation process to a reimbursable category. The designer and the constructor are reimbursed for the time spent on this early stage and the designer and the constructor are no longer reluctant to spend time on this work. As a result, the potential for discovering significant cost and/or time reduction opportunities in the incipient stage of the project is much higher than at later stages. Further examples of other possible reimbursable expenses are labor costs associated with evaluation of project budget, preliminary estimate of cost of the work, detailed estimate of cost of the work, owner supplied data coordination (including all FF&E and IST elements), value analysis, submittal services (including all shop drawing development, review, refinements and coordination with the constructor and designer) and supplemental documentation.

Once the reimbursables are identified, contracts between the members and owner must be drafted to assign hours spent on interactive cost estimating and conceptual design to a reimbursable category. The contracts must also include terms and conditions concerning compensation for the completed project. These are simply the base fees to be paid to the team members for completion of the project within a set time schedule. Other standard terms and conditions of basic construction contracts can be incorporated into the contract as well. Further, contracts must also be drafted to include and establish incentives such as an “Estimate Accuracy Pool” that will be shared based on the member's achievement of key “Design-To-Cost-Target” goals. For example but not by way of limitation, if the Schematic Design (SD)estimate is within + or −(a chosen percentage of)_% of final Guaranteed Maximum Price (“GMP”) to prevent shooting high or low, then the members will be awarded (a pre-agreed percentage)_% of the construction cost as an incentive to be distributed perhaps 70/30, or other ratio established as part of the contractual agreement or partnering contract. The team must consider the use of the BOLIVA model (Bottom Line Value Added) in place of fees. As an example: if a project was initially reasonably anticipated to be delivered in 16 months, but the team is able to deliver it in 12 months, and if the owner's business plan indicated expected revenues of $10,000 per day when the project is functioning, then early delivery by 4 months represents 120 days×$10,000/day=$1,200,000, half of which ($600,000) would be shared with the team, and distributed per the contractual and procedural rules governing shared savings, and, in this case, shared revenues. BOLIVA is an incentive based award for early completion of projects.

The next step involves conducting the proprietary TPS Training Workshop to lead the team to discover root causes, develop effective solutions, commit to the solutions, and to implement the solutions through the use of appropriate planning, policy, and procedures tools. The designer, the constructor, the owner and the team leader will codify and execute a partnering agreement that spells out the overarching goals and directions that the preceding actions are intended to achieve and/or reinforce. This includes a thorough discussion of compensation, reimbursement, incentives and agreement on guidelines for dispensations (e.g. 70/30 or some other ratio). The team leader is to monitor, adjust, and at key milestones, is to assess how well the process is achieving the goals defined in the partnering agreement. At project completion, the team leader will write a final assessment.

Implementation of TAP is predicated upon participation by a qualified team leader, (sometimes referred to as the “mediator”, “keeper of the fair and level playing field” and/or “referee”) to achieve focus, clarity, and guidance. The team leader achieves leadership through communication with and among the team based on anticipating issues, using common, clear language, and timing. The leader is responsible for building the team through well established cause and effect theory such as “Goldratt's Theory of Constraints: A Systems Approach to Continuous Improvement” by H. William Dettmer, 1997 and “Breaking the Constraints to World-Class Performance” by H. William Dettmer, 1998. These are offered by way of example and not limitation as other problem solving theories may be applied. As shown by example but not limitation in FIG. 1, the following are examples of actions that the team leader may take in order to implement TAP: approaching the entire process of design, construction and activation as a complete, interdependent system; guiding the team to identify root causes, develop actions to overcome the root causes and commit to implementation; guiding the team to a consensus on duties, a consensus on reasonable compensation, reimbursement and incentives; drafting contracts to codify, implement and support the Method; equal treatment of all team members; harmonizing and balancing; training the team; acting as a catalyst to make the team better; and preparing to act while there is time and freedom to act. Further actions of the team leader under a cause and effect theory include: communication of the importance of Capability, Overcoming Obstacles, and Incentives; identification of owner priorities and developing options with the team; sharing of success stories with the team, resulting in demonstrating what can be achieved; enhancing and developing the team; energizing the team for action; ensuring that the owner's interests are the first order of business by truth-telling; demonstrating why “sugar coating” destroys understanding; demonstrating why closure has to be the common passion; and show why confrontation can be good. There must be a commitment to TAP in order to counteract “fear driven” behavior and overcome the habit of “going along to get along”. The team must be mission driven with a focus on “Project Performance at Completion” as a major contribution to the owner's business plan and overall strategy. These goals are partially accomplished through the partnering agreement. The team must be oriented with a pro-active and affirmative posture and avoid reactive, negative and avoidance behavior. The team leader must emphasize responsibility in order to stop the feedback loop where people support and nourish the bureaucracy in contradiction to the team's stated purpose. Further, emphasizing responsibility breaks the chokehold of “Nobody is really responsible”. The team leader must control total project costs by establishing a valid and complete Total Project Budget (TPB), including construction costs, owner controlled reserves, design costs, FF&E, IST, and all owner direct costs; ensuring that the TPB is authorized by the proper entity within the owner's organization; tracking all base obligations (contracts and/or purchase orders), all authorized changes (formal, signed change orders or purchase order modifications), and payments against total obligations; identification (as early as feasible) of all probable/pending (potential) changes for every line item in the TPB; utilization of the rate of changes (approved changes+probable/pending to date divided by fraction of total project duration consumed to date) to calculate the Extrapolated-Cost-at-Completion (ECC) for every line in the TPB; comparing the ECC to the Approved Budget and reporting under or over budget. This must be performed continuously throughout the project and communicated to the team members.

Finally, a team leader under the TAP method must address and review the following, possibly with an effective facilitator: delays anywhere in the review cycle for proposed changes; clear presentations and confirmed owner understanding of the full implications (cost, time, quality) of proposed additions to the project, contingency impacts, delays (including late decisions), use of reserves on the overall project at completion; various members of the team will periodically lose track of the importance of remaining committed to the guiding principal of TOTAL (enthusiastic, cooperative, and timely) teamwork; various members of the team may have different understandings, at different times, of the underlying calculations for “earned incentives” (e.g. for conceptual estimating accuracy; for shared savings); the rules must be clear from the beginning, and reviewed periodically in order to avoid misunderstandings or false expectations, either of which can lead to resentment or conflict; contract provisions may be modified to address specific situations. For example: The designer agrees to cooperate in good faith with the development, drafting, and signing of a Partnering Agreement that will define key objectives and incentives designed to accomplish a result; the constructor will develop timely and accurate estimates of construction costs at each stage of the project, and generate, review and refine submittals and shop drawings, FF&E, IST as well as producing such documents in the optimum time-frames. The method and system set forth may be implemented in a variety of ways such as use of a computer system for compilation of data concerning designer and constructor selection, tracking information concerning conceptual design and pre-construction services, as well as generating data relating to risk assessment and root causes.

By way of example and not limitation, the method and system may be implemented on a construction project as follows: Plan and conduct the selection of the project designer according to TAP principals, to wit, along with quality of previous design work, and equal to it in importance, rank each firm's design schedule making it a requirement of the proposal, including labor assignments. Confirm the validity of the proposed schedule (i.e. the resources shown are available in the proposed time frames). Test proposed personnel for their grasp of their potential roles in cost estimating interaction and the effects on early design. Likewise test their grasp of their potential roles in “design completion” interaction during the review and refinement of key shop drawings and submittals. Consider the fee to be paid as a much lower priority on the list of evaluation criteria than is commonly the case.

Plan and conduct the selection of the project constructor according to TAP principals, to wit: Along with recommendations from other owners, safety record, etc., and equal to these in importance, evaluate and rank each firm's proposed pre-construction support services plan/schedule making it a requirement of the proposal, including labor assignments. Confirm the validity of the proposed schedule (i.e. the resources shown are available in the proposed time frames). Test proposed personnel for their grasp of their potential roles in cost estimating interaction and the effects on early design. Likewise test their grasp of their potential roles in “design completion” interaction during review/refinement of key shop drawings and submittals. Consider fee as much lower priority on the list of evaluation criteria than is commonly the case.

In the event the project designer was selected prior to application of any portion of the TAP methodology, then at least apply the same requirements for design schedule, resource assignments, and overall management of the design process. If possible, revise the contract to reflect these aspects. In the event the project constructor was selected prior to application of any portion of the TAP methodology, then at least apply the same requirements for pre-construction support services plan/schedule, resource assignments, and overall management of the design assistance and improvement process. Apply similar principals to the “design completion” interaction to be required during the review/refinement of key shop drawings and submittals. If possible, revise the contract to reflect these aspects.

Convert selected designer tasks to a reimbursable category according to TAP principals, to wit: identify the portions of each of the designer's work plan or schedule associated with: a) interactive cost estimating and conceptual design planning; b) interactive review and refinement of shop drawings and submittals. Take those portions out of the fee and convert them to a reimbursable category. Adjust the Total Project Budget to reflect these changes and to control them. Convert selected constructor tasks to a reimbursable category according to TAP principals, to wit: identify the portions of each constructor's work plan or schedule associated with: a) interactive cost estimating and conceptual design; b) interactive review and refinement of shop drawings and submittals. Take those portions out of the fee and convert them to reimbursables. Adjust the Total Project Budget to reflect these changes and to control them.

Provide compensation through an agreed upon fee or payment schedule based on timely and cost-effective delivery of the project. Compensation does not include reimbursables or incentives. Provide increased profit through incentive awards or bonuses such as, but not limited to, a conceptual construction cost estimating accuracy bonus earned by achieving accuracy specified in the contract documents, and paid from the Total Project Budget prior to any team generated cost savings; a “self funding” conceptual construction cost estimating accuracy bonus earned by achieving accuracy specified in the contract documents, and paid from the team generated cost savings (e.g. shared savings pool) prior to distribution and sharing of the remainder of the pool per the contractual and procedural rules governing shared savings; include a conceptual FF&E cost estimating accuracy bonus earned by achieving accuracy specified in the contract documents, and paid from the Total Project Budget prior to any team generated cost savings; include a “self funding” conceptual FF&E cost estimating accuracy bonus earned by achieving accuracy specified in the contract documents, and paid from the team generated cost savings (e.g. shared savings pool) prior to distribution and sharing of the remainder of the pool per the contractual and procedural rules governing shared savings; include a conceptual IST cost estimating accuracy bonus earned by achieving accuracy specified in the contract documents, and paid from the Total Project Budget prior to any team generated cost savings.

The bonuses or bonus structures provide incentives to team members motivating them to perform in an extraordinary manner. For example but not by way of limitation, assume that the constructor publishes the first schematic design estimate that subsequently is found to be within 1.5% of the final bid/award total. Also assume that the target for this bonus was +/−1.75% of the final price. This level of accuracy makes it possible for the owner to make important decisions early enough during the design phase to make use of the budget. The team is then awarded whatever bonus amount had been determined at the training workshops and agreed upon at the time the contracts were signed. Include also a cost reduction share that results from a member achieving a superior form of design or a more cost efficient way to accomplish a result. Any demonstrable cost savings will be shared with the team, either before or after paying the conceptual estimating accuracy bonus. “Self funding” for those projects that are urgently needed by the owner and an alternative approach is that either the designer or the constructor, or both, may propose to reduce their fees by some amount, commonly one half, in exchange for half of the expected additional revenues that will be derived, based on the owner's business plan for the new project, for delivery of the project earlier than initially expected (i.e BOLIVA). Any combination of the preceding may be performed and not depart from the spirit of TAP. As a variation of any of the above steps, exclude the owner's representative project manager or construction manager from the shared savings pool incentive program; or include the owner's representative project manager or construction manager advisor as a participant in the shared savings pool incentive program.

Draft or codify agreements to assign hours to be spent on preliminary tasks such as interactive cost estimating, conceptual design, interactive review and refinement of shop drawings and submittals to a reimbursable category. For example, a contract provision may include: “All Pre-Construction Services, such as preparation of cost estimates and schedules, shall be considered to reimbursable expenses and are excluded from the constructor's fee”. The agreement should also include a payment schedule or structure related to compensation. The payment structure includes monetary returns for project completion. Include incentives by establishing an “Estimate Accuracy Pool” that will be shared based on the team's achievement of key “Design-To-Cost-Target” goals. The following is an example of a contract provision between the owner and the constructor where the basis of payment is the Cost of the Work Plus a Fee with a negotiated Guaranteed Maximum Price: “Savings shall be recognized in the final event that the Cost of the Work plus constructor's Fee is less than the Guaranteed Maximum Price “GMP”, as amended by Change Orders. If Savings exist, and if the Schematic Design estimate submitted by the constructor is within 2% (two percent, plus or minus) of the GMP, then a portion of the Savings equal to (a pre-agreed upon percentage)_% of the GMP shall revert entirely to the constructor. If additional savings exist in excess of (a pre-determined percentage)_% of the GMP, then such additional Savings shall revert one-half to owner and one-half to constructor, except Allowance items for which any savings shall revert 100% to owner. Any savings earned by the constructor, as described above, shall be distributed to other contributing members of the team (primarily the designer) per the terms of the partnering agreement between them”. A further example is that if the Schematic Design estimate is within plus or minus (a set percentage)_% of final GMP (to prevent shooting high or low), then the team will be awarded (a set percentage)_% of the construction cost as an incentive to be distributed perhaps 70/30, or some other ratio established as part of the Partnering Agreement.

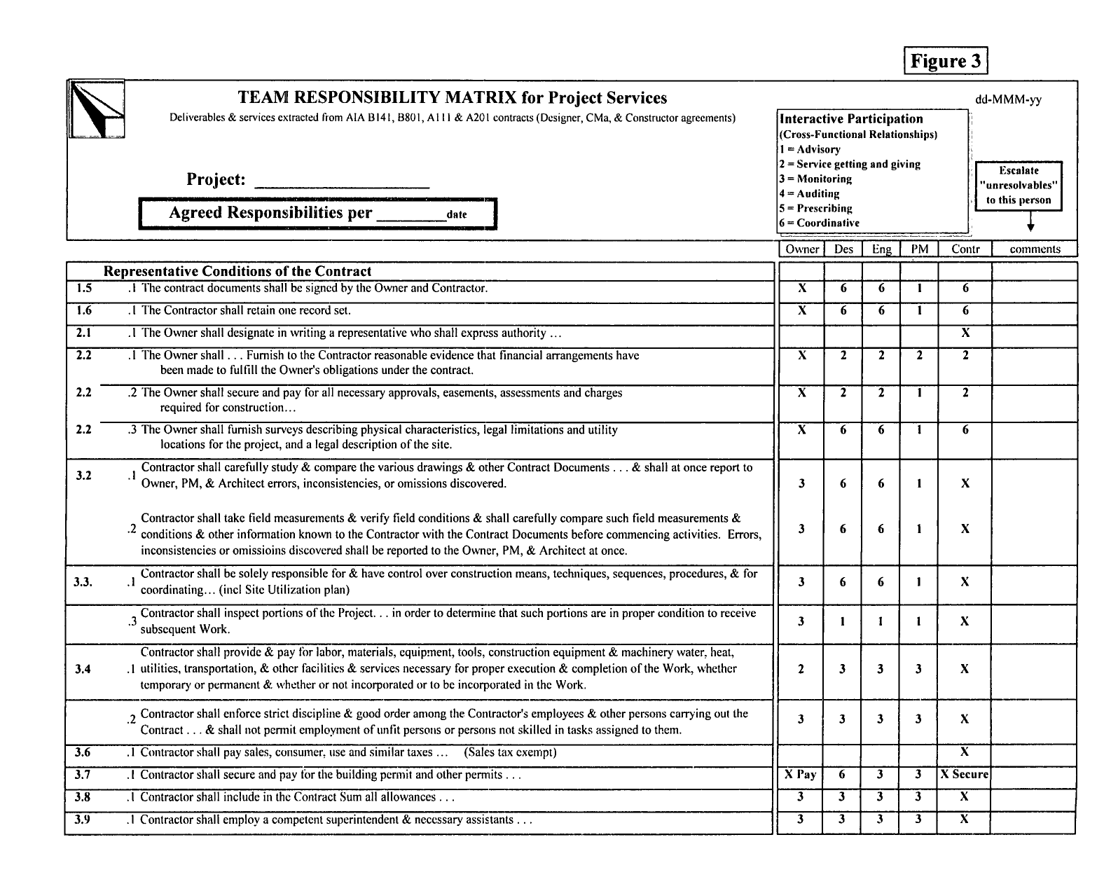

Conduct the proprietary TPS Training Workshop to lead the team to discover root causes, develop effective solutions, commit to the solutions, and to implement the solutions through the use of appropriate planning, policy, and procedures tools. For example, FIG. 3 demonstrates representative conditions of the partnering agreement relating to the contractor and owner. This represents a small portion of the overall Team Responsibility Matrix, which includes the designer, the owner, the constructor and the team leader responsibilities. The Matrix defines the duties and time schedules assigned to each along with the cross-functional relationships or interactive participation required of certain members. The interactive participation box defines the level of responsibility required of each team member, owner and team leader for each duty. The following is a representative list of some but not all of the duties included in the Matrix: complying with applicable laws, ordinances, rules and regulations of public authorities; uncovering and correction of work; analyze types and quantities of labor required; submit, update and revise a schedule of submittals; schedule and conduct pre-construction, construction and progress meetings; define and update the project construction schedule; if project falls behind, develop a recovery schedule; develop completion schedules; coordinate acquisition of Certificates of Occupancy and compliance with all permit requirements; and prepare and submit the Project Final Report. A computer database is used to generate and compile the list of duties as well as the level of responsibility (e.g. advisory, monitoring etc.) required from each team member for each duty.

Referring to FIGS. 1 and 2, the discovery of root causes and the development of solutions to the root causes is achieved through the training workshop. The following is an example of the method of discovering root causes, offered by way of example and not limitation. The team meets during the training workshop and all parties are asked to list observed undesirable effects in a given situation. These effects are often shown to cause further effects, similar to a tree with the basic causation at the root of the tree, hence root causes. Once identified, solutions are developed to overcome root causes. The designer, the constructor, and the owner will develop and sign a contractual agreement that spells out the overarching goals and directions that the preceding actions are intended to achieve and/or reinforce. This includes a thorough discussion of profit or compensation, reimbursement, bonuses and shared savings as well as an agreement on scheduling completion dates for each duty and guidelines for dispensations of any money (e.g. 70/30 or some other ratio).

In addition to the above, further aspects and embodiments will become apparent by reference to the drawings and by study of the preceding descriptions. Exemplary embodiments are illustrated in reference to Figures of the drawings. It is intended that the embodiments and Figures disclosed herein are to be considered illustrative rather than limiting.

I claim:

1. A method of project management and project delivery between an owner, one or more constructors and one or more designers comprising the steps of:
selecting team members comprised at least in part of constructor(s) and designer(s);
codifying agreements between said owner and said team members to:
(a) define each of said team members duties;
(b) provide for reimbursement to selected of said team members for performing preliminary tasks including but not limited to interactive conceptual design, pre-construction planning, interactive review of drawings and submittals, and design and cost estimates;
(c) provide for compensation of selected of said team members based on said duties; and
providing incentives to each of said team members as a means for motivating said team members.

2. The method according to claim 1 wherein said owner appoints a team leader to select said team members.

3. The method according to claim 2 wherein said step of selecting said team members includes utilization of TAP criteria.

4. The method according to claim 3 wherein said selection step includes utilization of criteria selected from the group consisting of quality of previous work, availability, grasp of interactive design completion and cost estimation and fees.

5. The method according to claim 1 wherein said method includes conducting training workshops to identify said duties, said reimbursement, said compensation and said incentives.

6. The method according to claim 5 wherein said training workshops further include identification of root causes.

7. The method according to claim 1 wherein said step of codifying agreements includes drafting and executing a contractual agreement between said owner and said team members.

8. The method according to claim 1 wherein at least one of said team members' duties include scheduled project completion.

9. The method according to claim 1 wherein said preliminary tasks include detailed pre-construction services and development, selection, estimation and installation of FF&E and IST.

10. The method according to claim 1 wherein said incentives include a conceptual estimating accuracy bonus, shared savings and BOLIVA.

11. A method of project management and project delivery defined by a team including members, an owner and a team leader, said method comprising the steps of:
defining each said members' duties;
drafting agreements to provide for reimbursement to selected of said members for preliminary tasks and to provide for compensation to said members based on completion of said duties;
executing said agreements between said members and said owner;
conducting training workshops with said members and said owner; and
providing a payment schedule to said members as a reward for extraordinary performance of said duties.

12. The method according to claim 11 wherein said method further includes the step of selecting said members by said team leader.

13. The method according to claim 12 wherein said selection step includes utilization of criteria selected from the group consisting of quality of previous work, availability, grasp of interactive design completion and estimation, and fees.

14. The method according to claim 11 wherein said training workshops include identification of root causes.

15. The method according to claim 11 wherein said members comprise designers and constructors.

16. The method according to claim 11 wherein said preliminary tasks include interactive design planning, pre-construction review and cost estimates.

17. The method according to claim 11 wherein said reward includes a conceptual estimating accuracy bonus, shared savings, and BOLIVA.

18. The method according to claim 11 wherein said step of conducting training workshops includes said team leader following the steps selected from the group consisting of guiding said members to identify root causes, develop actions to overcome said root causes and commit to implementation of said actions, identifying said owner's priorities, aiding said members in project completion, using BOLIVA as a model, emphasizing responsibility by each said members, controlling Total Project Budget, tracking all base obligations, tracking all authorized changes, reviewing delays, and calculating Extrapolated-Cost-at-Completion for Total Project Budget.

19. A method of project management and delivery of a construction project based on preliminary conceptual design and pre-construction planning, design and pre-construction estimates concerning cost, the method comprising:
selecting necessary parties based on TAP criteria;
identifying each of said necessary parties' duties and designating selected of said duties as reimbursable preliminary tasks;
determining a payment schedule to said necessary parties based on performance of duties not included as said reimbursable tasks;
awarding bonuses based on performance of said duties;
drafting and executing agreements between said necessary parties and an owner to include said reimbursable tasks, said payment schedule and said bonuses; and
conducting training workshops for said necessary parties and said owner.

20. The method according to claim 19 wherein said selection step includes utilization of said criteria selected from the group consisting of quality of previous work, availability, grasp of interactive design completion and estimation, and fees.

21. The method according to claim 19 wherein said training workshops include meetings involving said necessary parties and said owner.

22. A system of achieving timely and cost-effective project delivery on a construction project, said system comprising:
a database having a plurality of fields of information, selected of said fields corresponding but not limited to:
a selection module having a list of criteria for obtaining desired members;
a compensation module defined by payment structures;
a reimbursement module having a list of defined tasks;
an incentive module defined by bonus structures;
a training module; and
an agreement module.

23. The system according to claim 22 wherein retrieval of said selected of said fields enables display of categories of information selected from the group consisting of said selection module, said compensation module, said reimbursement module, said incentive module, said training module, and said agreement module.

24. The system according to claim 22 wherein said criteria are listed in a drop-down menu.

25. The system according to claim 22 wherein said payment structures include monetary returns for project completion.

26. The system according to claim 22 wherein said reimbursement module includes a payment schedule for said defined tasks.

27. The system according to claim 22 wherein said defined tasks include interactive participation between said members.

28. The system according to claim 22 wherein said agreement module includes a contract table for developing contract proposals specifying reimbursement, compensation and incentives.

29. The system according to claim 22 wherein said training module includes information relating to cause and effect logic to discover root causes of common problems and problem solving skills to obtain solutions.

30. The system according to claim 22 wherein said bonus structures include but are not limited to monetary bonuses for estimating accuracy, shared savings and BOLIVA.

31. The system according to claim 22 wherein said agreement module includes a responsibility matrix.

32. A system of construction project management and construction project delivery having a team defined by constructor(s), designer(s), owner and a team leader, said system comprising:
contractual agreements between said owner, said constructor(s) and said designer(s) to:
(a) identify said constructor(s) and said designer(s) duties;
(b) provide for reimbursement and compensation based on selected of said duties;
(c) training workshops to identify said duties, said compensation and said reimbursement; and
(d) bonus awards for defined performance standards.

33. The system according to claim 32 wherein said system includes selecting said constructor(s) and said designer(s) by said team leader.

34. The system according to claim 32 wherein said bonus awards include a conceptual estimating accuracy bonus, shared savings and BOLIVA.
